(19) United States
(12) Patent Application Publication
(10) Pub. No.: US 2013/0132837 A1
(43) Pub. Date: May 23, 2013

(54) ENTERTAINMENT DEVICE AND METHOD

(71) Applicants: Jonathan Selwyn Mead, London (GB); Craig Stuart Kerrison, London (GB); Fani Sazaklidou, London (GB)

(72) Inventors: Jonathan Selwyn Mead, London (GB); Craig Stuart Kerrison, London (GB); Fani Sazaklidou, London (GB)

(73) Assignee: SONY COMPUTER ENTERTAINMENT EUROPE LIMITED, London (GB)

(21) Appl. No.: 13/383,933

(22) PCT Filed: Jul. 14, 2010
(86) PCT No.: PCT/GB10/51155

§ 371 Date: Aug. 27, 2012

(30) Foreign Application Priority Data
Jul. 15, 2009 (GB) 0912311.8

(51) Int. Cl. G06F 3/0481

(52) U.S. Cl. CPC G06F 3/04815
USPC 715/716

(57) ABSTRACT

A method of administering a virtual dance floor for an entertainment device is provided. The virtual dance floor is part of an online virtual environment hosting multiple users each using a respective entertainment device. Each user is represented by an avatar. For each entertainment device, the method includes receiving, from an administrator of the online virtual environment, an indicator of music currently played on the virtual dance floor; initiating playback of the music from a locally stored copy in response to placement of the avatar of the respective user; detecting breakpoints in the currently played music; receiving from the administrator a music event signal; and in response to receiving the music event signal, selecting the next detected breakpoint in the currently played music and substituting that music at the selected breakpoint with a piece of music of a predetermined length that is substantially shorter than the currently played music.

The present invention relates to entertainment devices and methods.

In virtual environments it is frequently desired to foster or enable social interactions between users, who are typically represented in the virtual environment by a so-called ‘avatar’ or graphical representation of a user.

Therefore such virtual environments typically provide a wide variety spaces and activities that allow for participation by avatars, enabling their users to find others with common interests.

In the Home® system found on the Sony® Playstation 3® network, one activity is dancing. Different dances can be selected that reflect different moods, personalities and cultural backgrounds.

In current incarnations of the Home system, avatars can dance anywhere, and can do so without musical accompaniment. However, it is desirable to additionally provide a common dance space where a plurality of users may congregate to dance to music.

Consequently, it is also desirable that the dance space can automatically cater to a rapidly changing distribution of dance styles.

The present invention seeks to address this problem.

In a first aspect of the present invention, an entertainment device comprises a display generator arranged to generate for display a representation of an on-line virtual environment, and to generate for display within the representation of the on-line virtual environment an avatar controlled by a user of the entertainment device and one or more avatars corresponding to users of one or more remote entertainment devices, the avatars being animated in response to a replayed music track; a receiver operable to receive from an administrator of the online virtual environment an indicator of a music track currently selected for use in the virtual environment, and operable to receive from the administrator a music event signal; music data storage operable to store a local copy of one or more music tracks; and a processor operable to initiate playback of the selected music track from a locally stored copy in response to an initial placement of the user's avatar within the online virtual environment, and operable to detect breakpoints in the currently played music track; in which: the processor is operable to select the next breakpoint in the currently played music track following reception of a music event signal, and to substitute the currently played music track at the selected breakpoint with a shorter piece of music of a predetermined length that is shorter than that portion of the currently played music track that it replaces which remains unplayed at the time of the substitution.

In a second aspect of the present invention, a server arranged to administer a virtual environment, to which a plurality of remote entertainment devices may connect, wherein each remote entertainment device is represented within the virtual environment by an avatar, comprises a transmitter operable: (a) to transmit to each remote entertainment device an indicator of a music track currently selected for replay in the virtual environment; and (b) to transmit a music event signal to instruct the remote entertainment devices to substitute music currently played by each of the remote entertainment devices with a shorter piece of music of a predetermined length that is shorter than that portion of the music track that it replaces which remains unplayed at the time of the substitution.

In a third aspect of the present invention, a method of administering an online virtual environment for an entertainment device, wherein the virtual environment is operable to host a plurality of users each connecting to the online virtual environment using a respective entertainment device, and where each user is represented in the virtual environment by an avatar, and for each respective entertainment device, comprises the steps of: receiving from an administrator of the online virtual environment an indicator of the music currently being played; initiating playback of the music from a locally stored copy in response to an initial placement of the avatar of the respective user within the online virtual environment; detecting breakpoints in the currently played music; receiving from the administrator of the online virtual environment a music event signal; and in response to receiving the music event signal, selecting the next detected breakpoint in the currently played music, and substituting the currently played music at the selected breakpoint with a shorter piece of music of a predetermined length that is shorter than that portion of the currently played music that it replaces which remains unplayed at the time of the substitution.

In a fourth aspect of the present invention, a method of administering an online virtual environment for a server, wherein the online virtual environment is operable to host a plurality of users each connecting to the online virtual environment using a respective entertainment device, and where each user is represented in the virtual environment by an avatar, comprises the steps of: receiving from respective remote entertainment devices dance style information for their corresponding avatars; evaluating the number of avatars dancing each of a number of available dance styles; selecting a dominant dance style based upon the evaluation; detecting whether the dominant dance style changes between successive evaluations; selecting music responsive to the dominant dance style; and transmitting a music event signal to the remote entertainment devices to substitute the music currently played by each of the remote entertainment devices with a shorter piece of music of a predetermined length that is shorter than that portion of the music that it replaces which remains unplayed at the time of substitution, and then to subsequently play a piece of music responsive to the dominant dance style.

Advantageously, the above aspects provide a technique for substantially synchronising musical events on a dance floor populated by a plurality of remotely connected users without the need for centrally broadcasting (or ‘webcasting’) the music itself. Moreover the above technique enables quick musical reactivity to events in the virtual environment for all remotely connected participants, irrespective of where in the respective local playback of the dance floor music each participant's entertainment device is, by substituting a short common piece of segue music at the next break point that occurs in each respective rendition of the music; as this short piece concludes, a new musical event may begin substantially synchronously across all participating entertainment devices.

Further respective aspects and features of the invention are defined in the appended claims, and further advantages are described herein.

Embodiments of the present invention will now be described by way of example with reference to the accompanying drawings, in which:

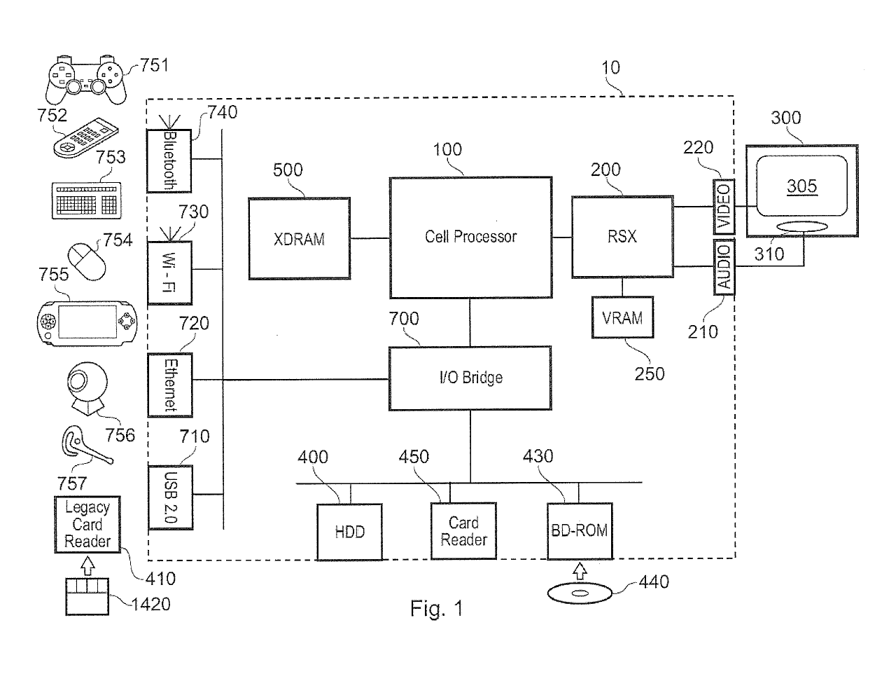

FIG. 1 is a schematic diagram of an entertainment device;

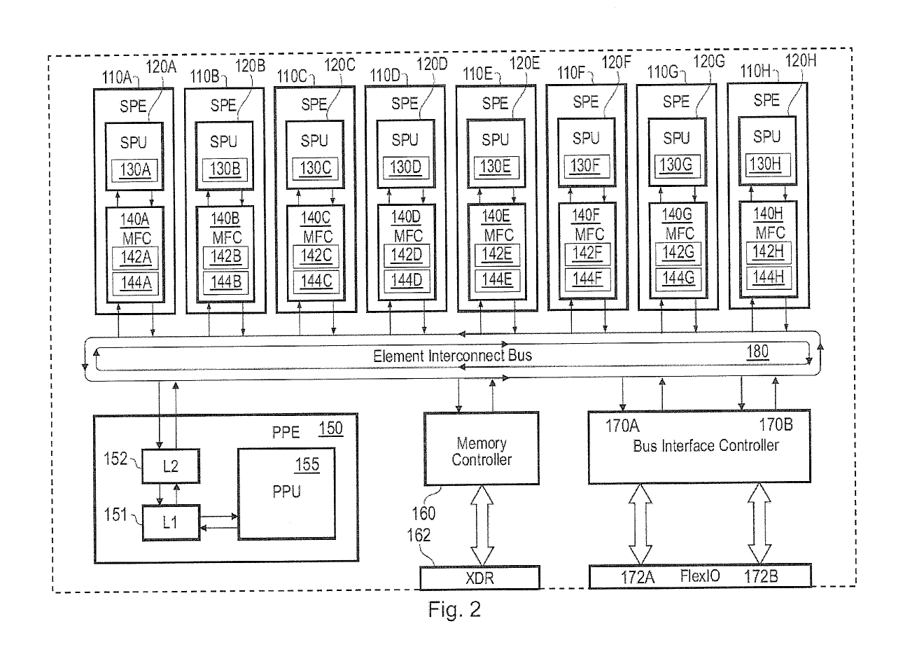

FIG. 2 is a schematic diagram of a cell processor;

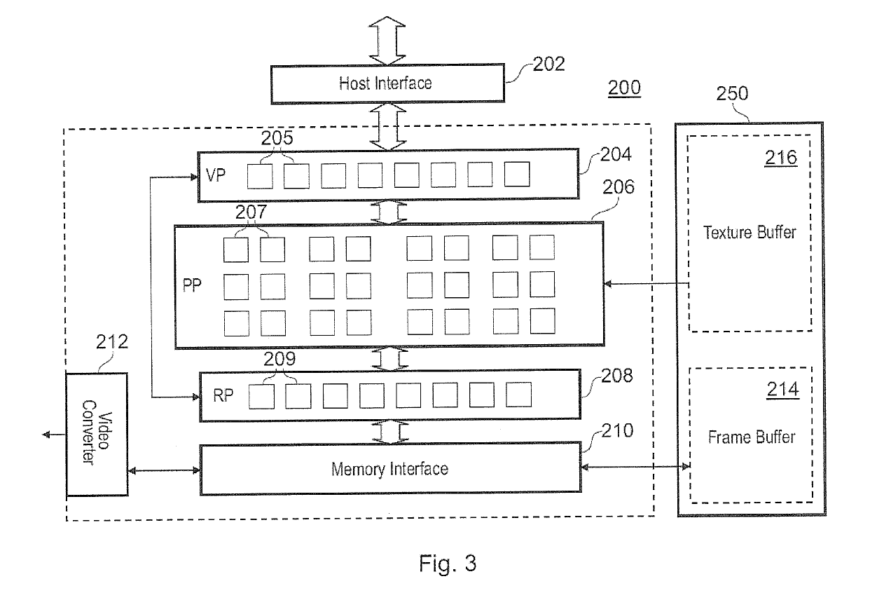

FIG. 3 is a schematic diagram of a video graphics processor;

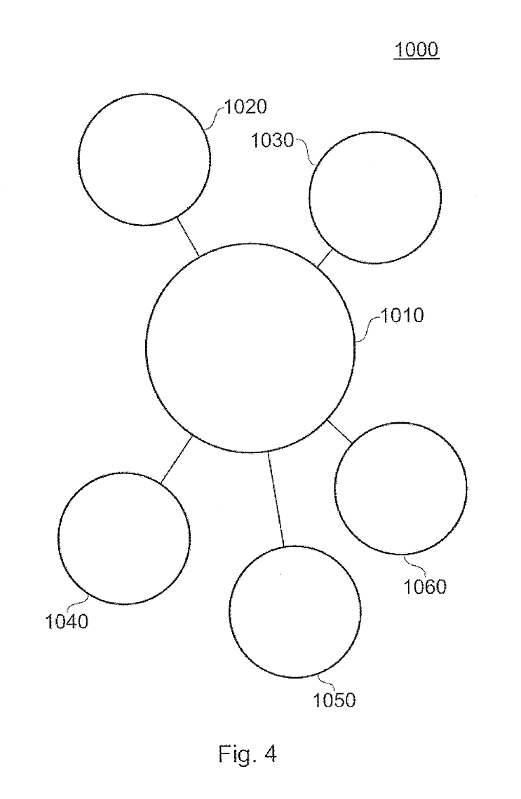

FIG. 4 is a schematic diagram of an interconnected set of game zones in accordance with an embodiment of the present invention;

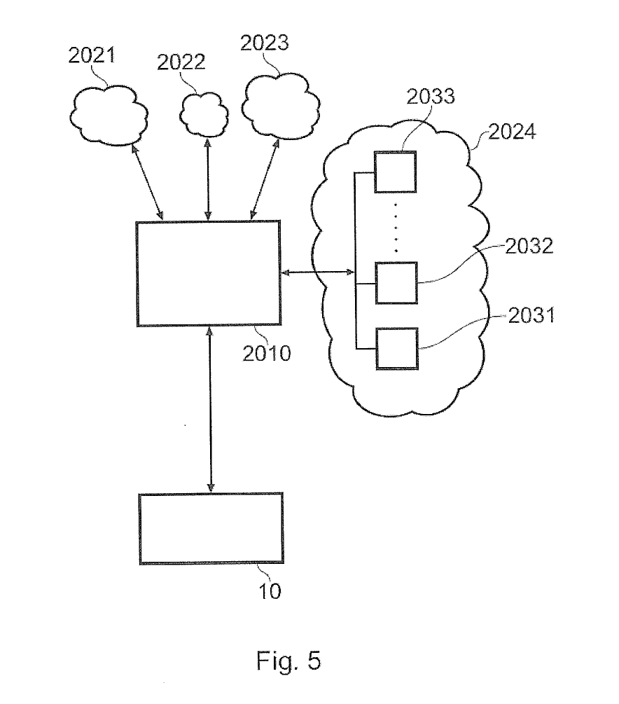

FIG. 5 is a schematic diagram of a Home environment online client/server arrangement in accordance with an embodiment of the present invention;

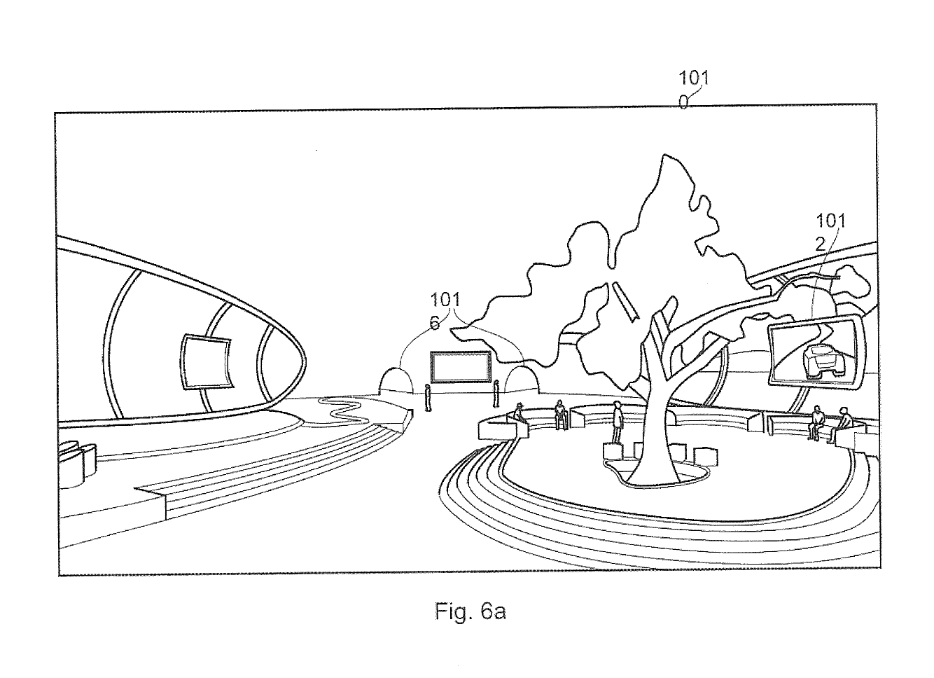

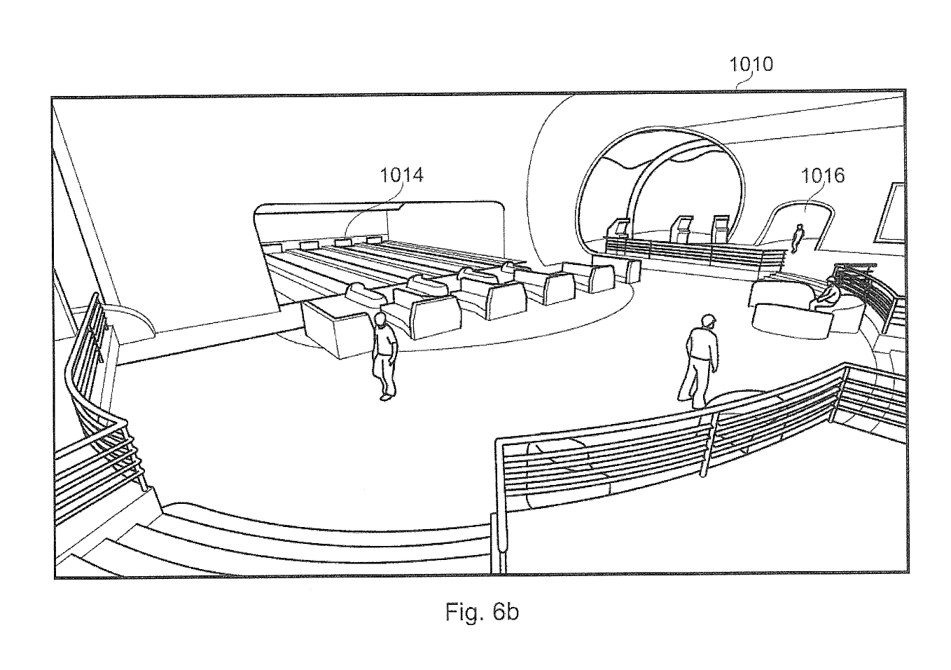

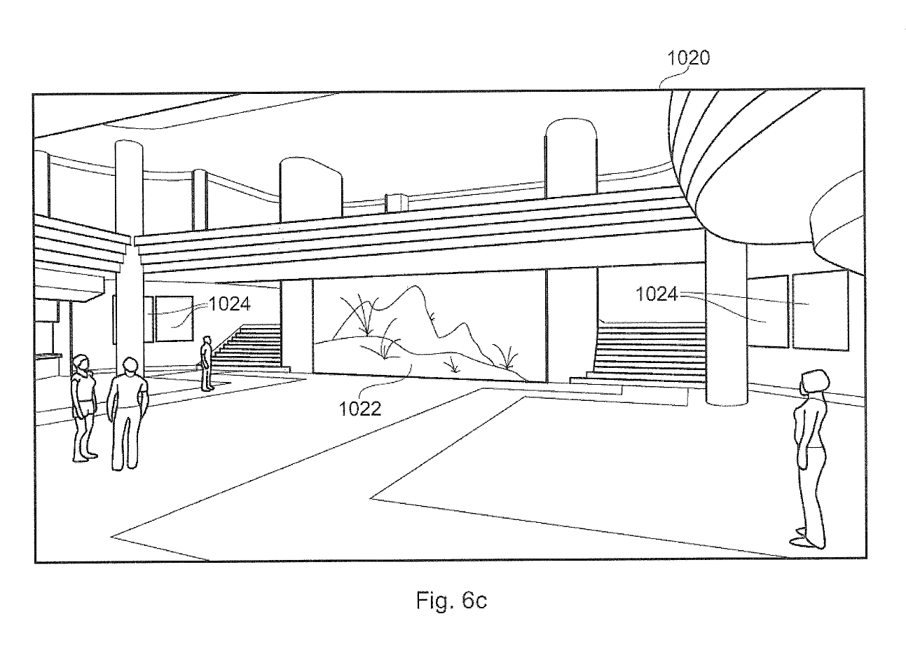

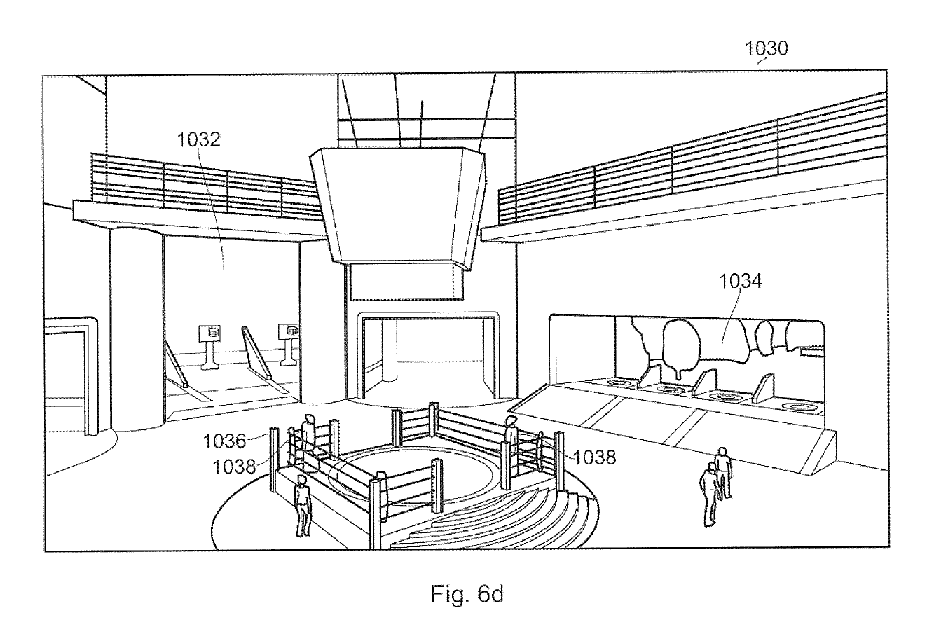

FIG. 6a is a schematic diagram of a lobby zone in accordance with an embodiment of the present invention;

FIG. 6b is a schematic diagram of a lobby zone in accordance with an embodiment of the present invention;

FIG. 6c is a schematic diagram of a cinema zone in accordance with an embodiment of the present invention;

FIG. 6d is a schematic diagram of a developer/publisher zone in accordance with an embodiment of the present invention;

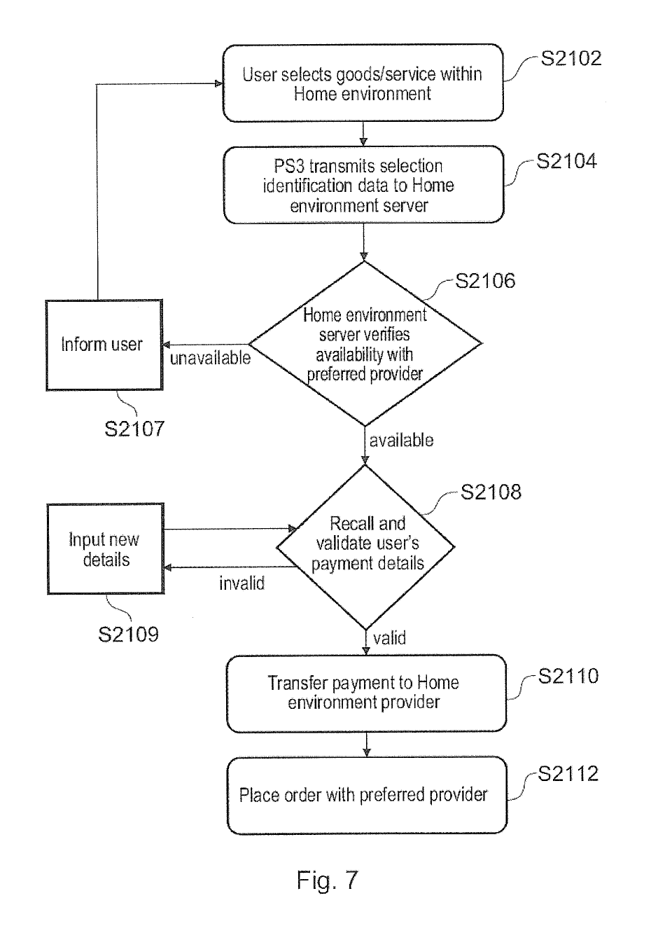

FIG. 7 is a flow diagram of a method of on-line transaction in accordance with an embodiment of the present invention;

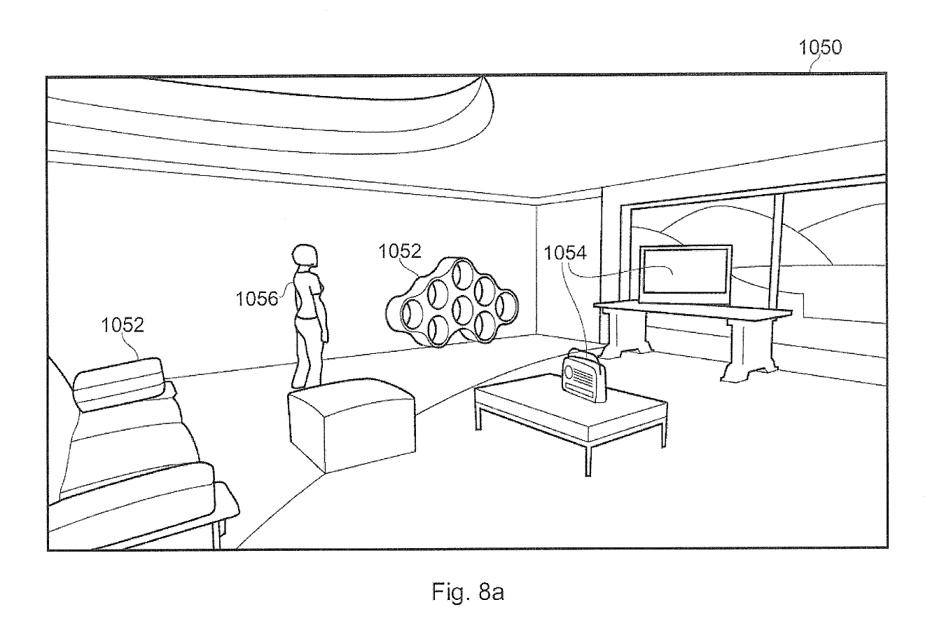

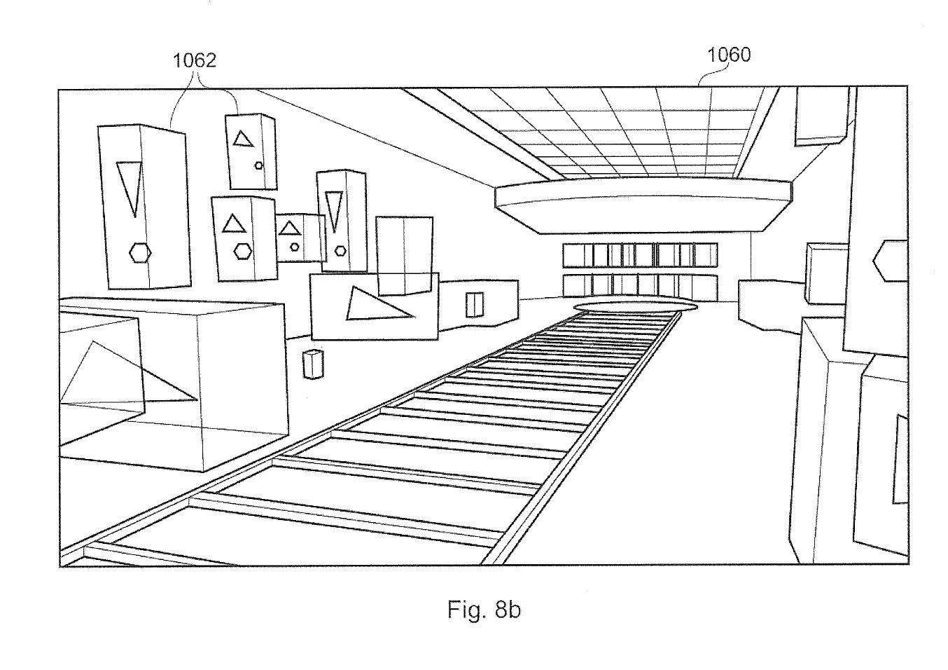

FIG. 8a is schematic diagram of an apartment zone in accordance with an embodiment of the present invention;

FIG. 8b is schematic diagram of a trophy room zone in accordance with an embodiment of the present invention;

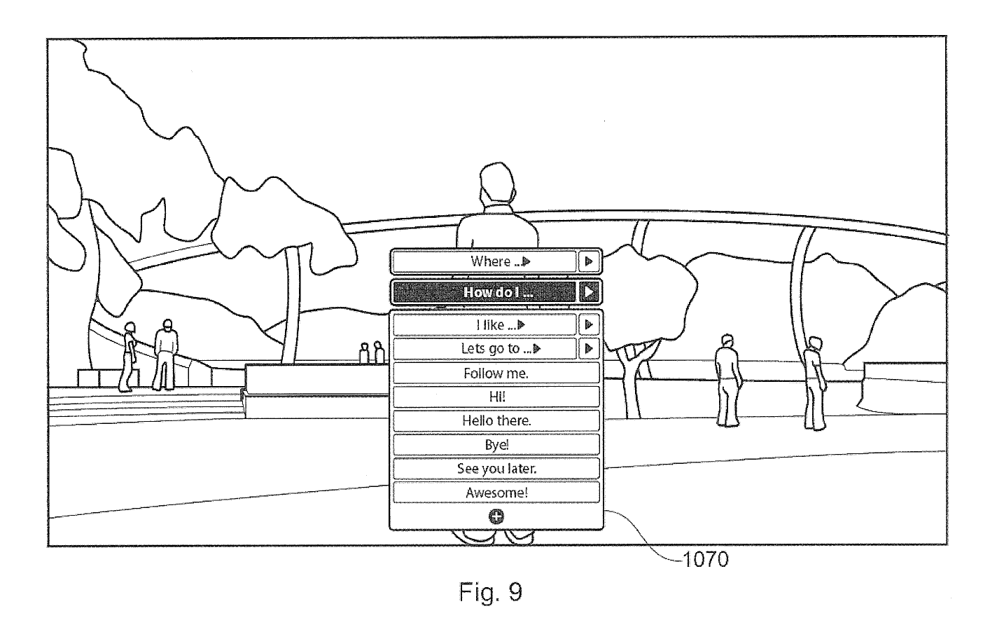

FIG. 9 is a schematic diagram of a communication menu in accordance with an embodiment of the present invention;

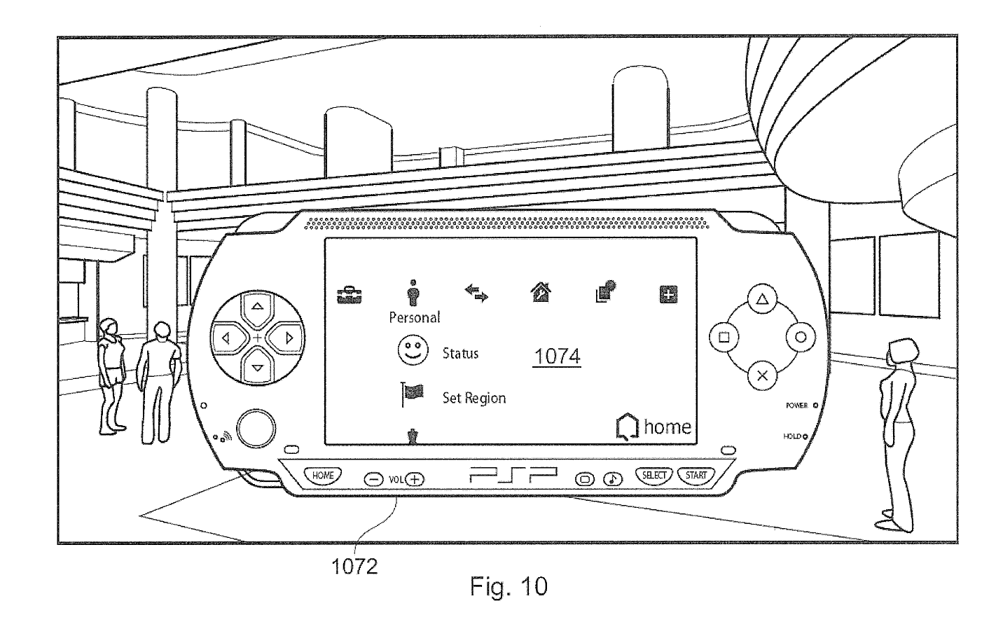

FIG. 10 is a schematic diagram of an interactive virtual user device in accordance with an embodiment of the present invention;

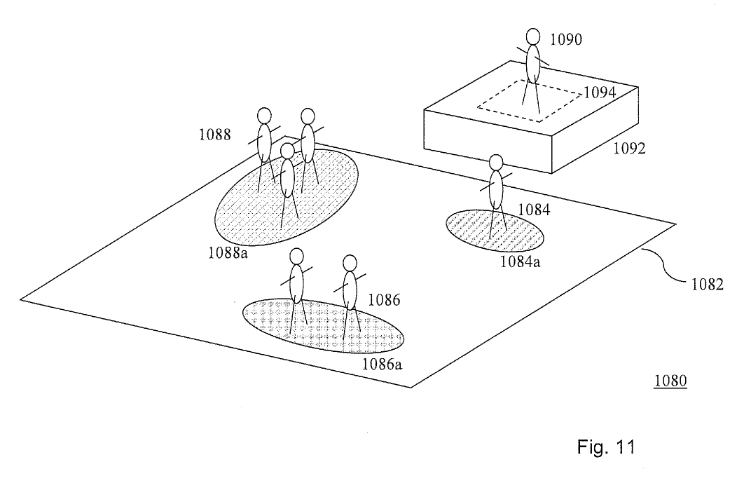

FIG. 11 is a schematic diagram of a virtual dance floor in a dance done in accordance with an embodiment of the present invention;

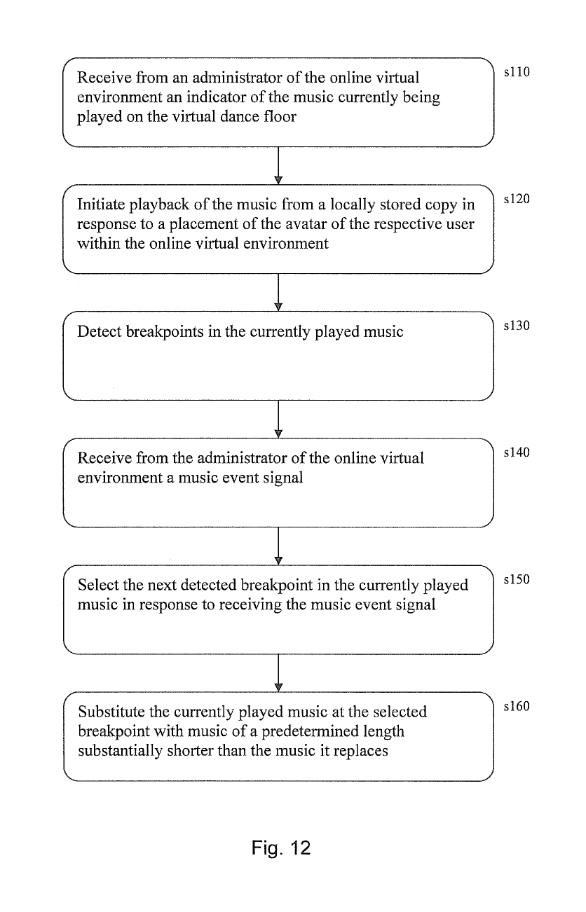

FIG. 12 is a flow diagram of a method of virtual dance floor administration done in accordance with an embodiment of the present invention; and

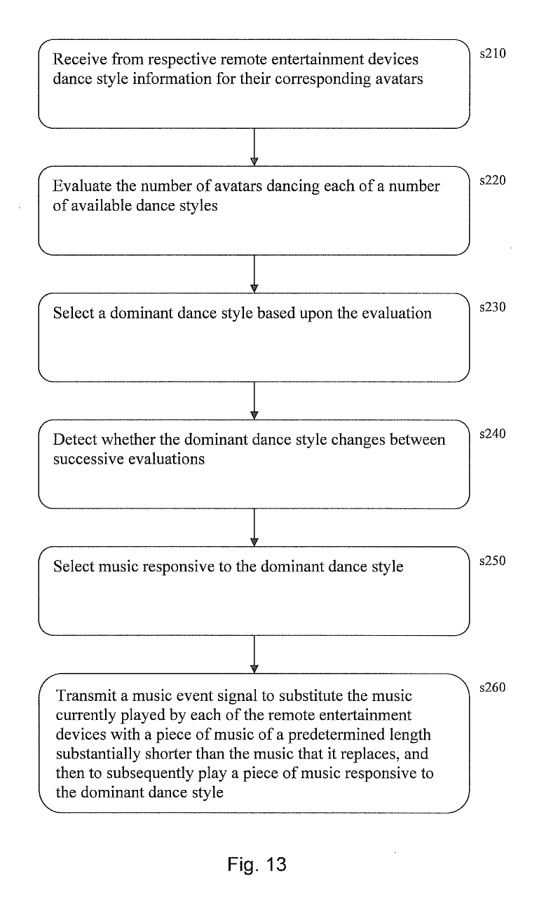

FIG. 13 is a flow diagram of a method of virtual dance floor administration done in accordance with an embodiment of the present invention.

An apparatus and method for a virtual dance floor are disclosed. In the following description, a number of specific details are presented in order to provide a thorough understanding of the embodiments of the present invention. It will be apparent, however, to a person skilled in the art that these specific details need not be employed to practise the present invention. Conversely, specific details known to the person skilled in the art are omitted for the purposes of clarity where appropriate.

FIG. 1 schematically illustrates the overall system architecture of the Sony® Playstation 3® entertainment device. A system unit 10 is provided, with various peripheral devices connectable to the system unit.

The system unit 10 comprises: a Cell processor 100; a Rambus® dynamic random access memory (XDRAM) unit 500; a Reality Synthesiser graphics unit 200 with a dedicated video random access memory (VRAM) unit 250; and an I/O bridge 700.

The system unit 10 also comprises a Blu Ray® Disk BD-ROM® optical disk reader 430 for reading from a disk 440 and a removable slot-in hard disk drive (HDD) 400, accessible through the I/O bridge 700. Optionally the system unit also comprises a memory card reader 450 for reading compact flash memory cards, Memory Stick® memory cards and the like, which is similarly accessible through the I/O bridge 700.

The I/O bridge 700 also connects to four Universal Serial Bus (USB) 2.0 ports 710; a gigabit Ethernet port 720; an IEEE 802.11b/g wireless network (Wi-Fi) port 730; and a Bluetooth® wireless link port 740 capable of supporting up to seven Bluetooth connections.

In operation the I/O bridge 700 handles all wireless, USB and Ethernet data, including data from one or more game controllers 751. For example when a user is playing a game, the I/O bridge 700 receives data from the game controller 751 via a Bluetooth link and directs it to the Cell processor 100, which updates the current state of the game accordingly.

The wireless, USB and Ethernet ports also provide connectivity for other peripheral devices in addition to game controllers 751, such as: a remote control 752; a keyboard 753; a mouse 754; a portable entertainment device 755 such as a Sony Playstation Portable® entertainment device; a video camera such as an EyeToy® video camera 756; and a microphone headset 757. Such peripheral devices may therefore in principle be connected to the system unit 10 wirelessly; for example the portable entertainment device 755 may communicate via a Wi-Fi ad-hoc connection, whilst the microphone headset 757 may communicate via a Bluetooth link.

The provision of these interfaces means that the Playstation 3 device is also potentially compatible with other peripheral devices such as digital video recorders (DVRs), set-top boxes, digital cameras, portable media players, Voice over IP telephones, mobile telephones, printers and scanners.

In addition, a legacy memory card reader 410 may be connected to the system unit via a USB port 710, enabling the reading of memory cards 420 of the kind used by the Playstation® or Playstation 2® devices.

In the present embodiment, the game controller 751 is operable to communicate wirelessly with the system unit 10 via the Bluetooth link. However, the game controller 751 can instead be connected to a USB port, thereby also providing power by which to charge the battery of the game controller 751. In addition to one or more analogue joysticks and conventional control buttons, the game controller is sensitive to motion in 6 degrees of freedom, corresponding to translation and rotation in each axis. Consequently gestures and movements by the user of the game controller may be translated as inputs to a game in addition to or instead of conventional button or joystick commands. Optionally, other wirelessly enabled peripheral devices such as the Playstation Portable device may be used as a controller. In the case of the Playstation Portable device, additional game or control information (for example, control instructions or number of lives) may be provided on the screen of the device. Other alternative or supplementary control devices may also be used, such as a dance mat (not shown), a light gun (not shown), a steering wheel and pedals (not shown) or bespoke controllers, such as a single or several large buttons for a rapid-response quiz game (also not shown).

The remote control 752 is also operable to communicate wirelessly with the system unit 10 via a Bluetooth link. The remote control 752 comprises controls suitable for the operation of the Blu Ray Disk BD-ROM reader 430 and for the navigation of disk content.

The Blu Ray Disk BD-ROM reader 430 is operable to read CD-ROMs compatible with the Playstation and PlayStation 2 devices, in addition to conventional pre-recorded and recordable CDs, and so-called Super Audio CDs. The reader 430 is also operable to read DVD-ROMs compatible with the Playstation 2 and PlayStation 3 devices, in addition to conventional pre-recorded and recordable DVDs. The reader 430 is further operable to read BD-ROMs compatible with the Playstation 3 device, as well as conventional pre-recorded and recordable Blu-Ray Disks.

The system unit 10 is operable to supply audio and video, either generated or decoded by the Playstation 3 device via the Reality Synthesiser graphics unit 200, through audio and video connectors to a display and sound output device 300 such as a monitor or television set having a display 305 and one or more loudspeakers 310. The audio connectors 210 may include conventional analogue and digital outputs whilst the video connectors 220 may variously include component video, S-video, composite video and one or more High Definition Multimedia Interface (HDMI) outputs. Consequently, video output may be in formats such as PAL or NTSC, or in 720p, 1080i or 1080p high definition.

Audio processing (generation, decoding and so on) is performed by the Cell processor 100. The Playstation 3 device's operating system supports Dolby® 5.1 surround sound, Dolby® Theatre Surround (DTS), and the decoding of 7.1 surround sound from Blu-Ray® disks.

In the present embodiment, the video camera 756 comprises a single charge coupled device (CCD), an LED indicator, and hardware-based real-time data compression and encoding apparatus so that compressed video data may be transmitted in an appropriate format such as an intra-image based MPEG (motion picture expert group) standard for decoding by the system unit 10. The camera LED indicator is arranged to illuminate in response to appropriate control data from the system unit 10, for example to signify adverse lighting conditions. Embodiments of the video camera 756 may variously connect to the system unit 10 via a USB, Bluetooth or Wi-Fi communication port. Embodiments of the video camera may include one or more associated microphones and also be capable of transmitting audio data. In embodiments of the video camera, the CCD may have a resolution suitable for high-definition video capture. In use, images captured by the video camera may for example be incorporated within a game or interpreted as game control inputs.

In general, in order for successful data communication to occur with a peripheral device such as a video camera or remote control via one of the communication ports of the system unit 10, an appropriate piece of software such as a device driver should be provided. Device driver technology is well-known and will not be described in detail here, except to say that the skilled man will be aware that a device driver or similar software interface may be required in the present embodiment described.

Referring now to FIG. 2, the Cell processor 100 has an architecture comprising four basic components: external input and output structures comprising a memory controller 160 and a dual bus interface controller 170A,B; a main processor referred to as the Power Processing Element 150; eight co-processors referred to as Synergistic Processing Elements (SPEs) 110A-H; and a circular data bus connecting the above components referred to as the Element Interconnect Bus 180. The total floating point performance of the Cell processor is 218 GFLOPS, compared with the 6.2 GFLOPs of the Playstation 2 device's Emotion Engine.

The Power Processing Element (PPE) 150 is based upon a two-way simultaneous multithreading Power 970 compliant PowerPC core (PPU) 155 running with an internal clock of 3.2 GHz. It comprises a 512 kB level 2 (L2) cache and a 32 kB level 1 (L1) cache. The PPE 150 is capable of eight single position operations per clock cycle, translating to 25.6 GFLOPs at 3.2 GHz. The primary role of the PPE 150 is to act as a controller for the Synergistic Processing Elements 110A-H, which handle most of the computational workload. In operation the PPE 150 maintains a job queue, scheduling jobs for the Synergistic Processing Elements 110A-H and monitoring their progress. Consequently each Synergistic Processing Element 110A-H runs a kernel whose role is to fetch a job, execute it and synchronise with the PPE 150.

Each Synergistic Processing Element (SPE) 110A-H comprises a respective Synergistic Processing Unit (SPU) 120A-H, and a respective Memory Flow Controller (MFC) 140A-H comprising in turn a respective Dynamic Memory Access Controller (DMAC) 142A-H, a respective Memory Management Unit (MMU) 144A-H and a bus interface (not shown). Each SPU 120A-H is a RISC processor clocked at 3.2 GHz and comprising 256 kB local RAM 130A-H, expandable in principle to 4 GB. Each SPE gives a theoretical 25.6 GFLOPS of single precision performance. An SPU can operate on 4 single precision floating point members, 4 32-bit numbers, 8 16-bit integers, or 16 8-bit integers in a single clock cycle. In the same clock cycle it can also perform a memory operation. The SPU 120A-H does not directly access the system memory XDRAM 500; the 64-bit addresses formed by the SPU 120A-H are passed to the MFC 140A-H which instructs its DMA controller 142A-H to access memory via the Element Interconnect Bus 180 and the memory controller 160.

The Element Interconnect Bus (EIB) 180 is a logically circular communication bus internal to the Cell processor 100 which connects the above processor elements, namely the PPE 150, the memory controller 160, the dual bus interface 170A,B and the 8 SPEs 110A-H, totaling 12 participants. Participants can simultaneously read and write to the bus at a rate of 8 bytes per clock cycle. As noted previously, each SPE 110A-H comprises a DMAC 142A-H for scheduling longer read or write sequences. The EIB comprises four channels, two each in clockwise and anti-clockwise directions. Consequently for twelve participants, the longest step-wise data-flow between any two participants is six steps in the appropriate direction. The theoretical peak instantaneous EIB bandwidth for 12 slots is therefore 96 B per clock, in the event of full utilisation through arbitration between participants. This equates to a theoretical peak bandwidth of 307.2 GB/s (gigabytes per second) at a clock rate of 3.2 GHz.

The memory controller 160 comprises an XDRAM interface 162, developed by Rambus Incorporated. The memory controller interfaces with the Rambus XDRAM 500 with a theoretical peak bandwidth of 25.6 GB/s.

The dual bus interface 170A,B comprises a Rambus FlexIO® system interface 172A,B. The interface is organised into 12 channels each being 8 bits wide, with five paths being inbound and seven outbound. This provides a theoretical peak bandwidth of 62.4 GB/s (36.4 GB/s outbound, 26 GB/s inbound) between the Cell processor and the I/O Bridge 700 via controller 170A and the Reality Simulator graphics unit 200 via controller 170B.

Data sent by the Cell processor 100 to the Reality Simulator graphics unit 200 will typically comprise display lists, being a sequence of commands to draw vertices, apply textures to polygons, specify lighting conditions, and so on.

Referring now to FIG. 3, the Reality Simulator graphics (RSX) unit 200 is a video accelerator based upon the NVidia® G70/71 architecture that processes and renders lists of commands produced by the Cell processor 100. The RSX unit 200 comprises a host interface 202 operable to communicate with the bus interface controller 170B of the Cell processor 100; a vertex pipeline 204 (VP) comprising eight vertex shaders 205; a pixel pipeline 206 (PP) comprising 24 pixel shaders 207; a render pipeline 208 (RP) comprising eight render output units (ROPs) 209; a memory interface 210; and a video converter 212 for generating a video output. The RSX 200 is complemented by 256 MB double data rate (DDR) video RAM (VRAM) 250, clocked at 600 MHz and operable to interface with the RSX 200 at a theoretical peak bandwidth of 25.6 GB/s. In operation, the VRAM 250 maintains a frame buffer 214 and a texture buffer 216. The texture buffer 216 provides textures to the pixel shaders 207, whilst the frame buffer 214 stores results of the processing pipelines. The RSX can also access the main memory 500 via the EIB 180, for example to load textures into the VRAM 250.

The vertex pipeline 204 primarily processes deformations and transformations of vertices defining polygons within the image to be rendered.

The pixel pipeline 206 primarily processes the application of colour, textures and lighting to these polygons, including any pixel transparency, generating red, green, blue and alpha (transparency) values for each processed pixel. Texture mapping may simply apply a graphic image to a surface, or may include bump-mapping (in which the notional direction of a surface is perturbed in accordance with texture values to create highlights and shade in the lighting model) or displacement mapping (in which the applied texture additionally perturbs vertex positions to generate a deformed surface consistent with the texture).

The render pipeline 208 performs depth comparisons between pixels to determine which should be rendered in the final image. Optionally, if the intervening pixel process will not affect depth values (for example in the absence of transparency or displacement mapping) then the render pipeline and vertex pipeline 204 can communicate depth information between them, thereby enabling the removal of occluded elements prior to pixel processing, and so improving overall rendering efficiency. In addition, the render pipeline 208 also applies subsequent effects such as full-screen anti-aliasing over the resulting image.

Both the vertex shaders 205 and pixel shaders 207 are based on the shader model 3.0 standard. Up to 136 shader operations can be performed per clock cycle, with the combined pipeline therefore capable of 74.8 billion shader operations per second, outputting up to 840 million vertices and 10 billion pixels per second. The total floating point performance of the RSX 200 is 1.8 TFLOPS.

Typically, the RSX 200 operates in close collaboration with the Cell processor 100; for example, when displaying an explosion, or weather effects such as rain or snow, a large number of particles must be tracked, updated and rendered within the scene. In this case, the PPU 155 of the Cell processor may schedule one or more SPEs 110A-H to compute the trajectories of respective batches of particles. Meanwhile, the RSX 200 accesses any texture data (e.g. snowflakes) not currently held in the video RAM 250 from the main system memory 500 via the element interconnect bus 180, the memory controller 160 and a bus interface controller 170B. The or each SPE 110A-H outputs its computed particle properties (typically coordinates and normals, indicating position and attitude) directly to the video RAM 250; the DMA controller 142A-H of the or each SPE 110A-H addresses the video RAM 250 via the bus interface controller 170B. Thus in effect the assigned SPEs become part of the video processing pipeline for the duration of the task.

In general, the PPU 155 can assign tasks in this fashion to six of the eight SPEs available; one SPE is reserved for the operating system, whilst one SPE is effectively disabled. The disabling of one SPE provides a greater level of tolerance during fabrication of the Cell processor, as it allows for one SPE to fail the fabrication process. Alternatively if all eight SPEs are functional, then the eighth SPE provides scope for redundancy in the event of subsequent failure by one of the other SPEs during the life of the Cell processor.

The PPU 155 can assign tasks to SPEs in several ways. For example, SPEs may be chained together to handle each step in a complex operation, such as accessing a DVD, video and audio decoding, and error masking, with each step being assigned to a separate SPE. Alternatively or in addition, two or more SPEs may be assigned to operate on input data in parallel, as in the particle animation example above.

Software instructions implemented by the Cell processor 100 and/or the RSX 200 may be supplied at manufacture and stored on the HDD 400, and/or may be supplied on a data carrier or storage medium such as an optical disk or solid state memory, or via a transmission medium such as a wired or wireless network or internet connection, or via combinations of these.

The software supplied at manufacture comprises system firmware and the Playstation 3 device's operating system (OS). In operation, the OS provides a user interface enabling a user to select from a variety of functions, including playing a game, listening to music, viewing photographs, or viewing a video. The interface takes the form of a so-called cross media-bar (XMB), with categories of function arranged horizontally. The user navigates by moving through the function icons (representing the functions) horizontally using the game controller 751, remote control 752 or other suitable control device so as to highlight a desired function icon, at which point options pertaining to that function appear as a vertically scrollable list of option icons centred on that function icon, which may be navigated in analogous fashion. However, if a game, audio or movie disk 440 is inserted into the BD-ROM optical disk reader 430, the Playstation 3 device may select appropriate options automatically (for example, by commencing the game), or may provide relevant options (for example, to select between playing an audio disk or compressing its content to the HDD 400).

In addition, the OS provides an on-line capability, including a web browser, an interface with an on-line store from which additional game content, demonstration games (demos) and other media may be downloaded, and a friends management capability, providing on-line communication with other Playstation 3 device users nominated by the user of the current device; for example, by text, audio or video depending on the peripheral devices available. The on-line capability also provides for on-line communication, content download and content purchase during play of a suitably configured game, and for updating the firmware and OS of the Playstation 3 device itself. It will be appreciated that the term “on-line” does not imply the physical presence of wires, as the term can also apply to wireless connections of various types.

In an embodiment of the present invention, the above-mentioned online capability comprises interaction with a virtual environment populated by avatars (graphical representations) of the user of the PS3 10 and of other PS3 users who are currently online.

The software to enable the virtual interactive environment is typically resident on the HDD 400, and can be upgraded and/or expanded by software that is downloaded, or stored on optical disk 440, or accessed by any other suitable means. Alternatively, the software may reside on a flash memory card 420, optical disk 440 or a central server (not shown). In running the software, the Cell Processor 100 and the RSX 200 collectively act as a display generator to display a representation of the on-line virtual environment and to generate for display within the representation of the on-line virtual environment an avatar controlled by a user of the PS3 10 and one or more avatars corresponding to users of one or more other PS3s who are currently online (and are therefore connected by an online or internet connection to the current PS3).

In an embodiment of the present invention, the virtual interactive environment (hereafter called the ‘Home’ environment) is selected from the cross-media bar. The Home environment then starts in a conventional manner similar to a 3D video game by loading and executing control software, loading 3D models and textures into video memory 250, and rendering scenes depicting the Home environment. Alternatively or in addition, the Home environment can be initiated by other programs, such as a separate game.

Referring now to FIG. 4, which displays a notional map of the Home environment, and FIG. 5, which is a schematic diagram of a Home environment online client/server arrangement, the user's avatar is spawned within a lobby zone 1010 by default. However, a user can select among other zones 1010-1060 (detailed below) of the map, causing the selected zone to be loaded and the avatar to be spawned within that zone. In an embodiment of the present invention, the map screen further comprises a sidebar on which the available zones may be listed, together with management tools such as a ranking option, enabling zones to be listed in order of user preference, or such as most recently added and/or A-Z listings. In addition a search interface may allow the user to search for a zone by name. In an embodiment of the present invention, there maybe many more zones available than are locally stored on the user's PS3 at any one time; the local availability may be colour coded on the list, or the list may be filtered to only display locally available zones. If the user selects a locally unavailable zone, it can be downloaded from a Home environment Server 2010.

Referring now to FIG. 6a, the lobby zone 1010 typically resembles a covered piazza, to and may comprise parkland (grass, trees, sculptures etc.), and gathering spaces (such as open areas, single benches or rows of seats etc.) where users can meet through their avatars.

The lobby zone 1010 typically also comprises advertisement hoardings, for displaying either still or moving adverts for games or other content or products. These may be on the walls of the lobby, or may stand alone.

The lobby zone 1010 may also include an open-air cinema 1012 showing trailers, high-profile adverts or other content from third-party providers. Such content is typically streamed or downloaded from a Home environment server 2010 to which the PS3 10 connects when the Home environment is loaded, as described in more detail later.

The cinema screen is accompanied by seating for avatars in front of it, such that when an avatar sits down, the camera angle perceived by the user of the avatar also encompasses the screen.

Referring now also to FIG. 6b, the lobby zone 1010 may also include general amusements 1014, such as functioning pool tables, bowling alleys, and/or a video arcade. Games of pool or bowling may be conducted via the avatar, such that the avatar holds the pool cue or bowling ball, and is controlled in a conventional manner for such games. In the video arcade, if an avatar approaches a videogame machine, the Home environment may switch to a substantially full-screen representation of the videogame selected. Such games may, for example, be classic arcade or console games such as Space Invaders®, or Pac-Man®, which are comparatively small in terms of memory and processing and can be emulated by the PS3 within the Home environment or run as plug-ins to the Home environment. In this case, typically the user will control the game directly, without representation by the avatar. The game will switch back to the default Home environment view if the user quits the game, or causes the avatar to move away from the videogame machine. In addition to classic arcade games, user-created game content may be featured on one or more of the virtual video game machines. Such content may be the subject of on-line competitions to be featured in such a manner, with new winning content downloaded on a regular basis.

In addition to the lobby zone 1010, other zones (e.g. zones 1020, 1030, 1040, 1050 and 1060, which may be rooms, areas or other constructs) are available. These may be accessed either via a map screen similar in nature to that of FIG. 4, or alternatively the user can walk to these other areas by guiding their avatar to various exits 1016 from the lobby.

Typically, an exit 1016 takes the form of a tunnel or corridor (but may equally take the form of an anteroom) to the next area. While the avatar is within the tunnel or anteroom, the next zone is loaded into memory. Both the lobby and the next zone contain identical models of the tunnel or anteroom, or the model is a common resource to both. In either case, the user's avatar is relocated from the lobby-based version to the new zone-based version of the tunnel or anteroom at the same position. In this way the user's avatar can apparently walk seamlessly throughout the Home environment, without the need to retain the whole environment in memory at the same time.

Referring now also to FIG. 6c, one available zone is a Cinema zone 1020. The Cinema zone 1020 resembles a multiplex cinema, comprising a plurality of screens that may show content such as trailers, movies, TV programmes, or adverts downloaded or streamed from a Home environment server 2010 as noted previously and detailed below, or may show content stored on the HDD 400 or on an optical disk 440, such as a Blu-Ray disk.

Typically, the multiplex cinema will have an entrance area featuring a screen 1022 on which high-profile trailers and adverts may be shown to all visitors, together with poster adverts 1024, typically but not limited to featuring upcoming movies. Specific screens and the selection and display of the trailers and posters can each be restricted according to the age of the user, as registered with the PS3. This age restriction can be applied to any displayed content to which an age restriction tag is associated, in any of the zones within the Home environment.

In addition, in an embodiment of the present invention the multiplex cinema provides a number of screen rooms in which featured content is available, and amongst which the user can select. Within a screen room downloaded, streamed or locally stored media can be played within a virtual cinema environment, in which the screen is set in a room with rows of seats, screen curtains, etc. The cinema is potentially available to all users in the Home environment, and so the avatars of other users may also be visible, for example watching commonly streamed material such as a web broadcast. Alternatively, the user can zoom in so that the screen occupies the full viewing area.

Referring now also to FIG. 6d, another type of zone is a developer or publisher zone 1030. Typically, there may be a plurality of such zones available. Optionally, each may have its own exit from the lobby area 1010, or alternatively some or all may share an exit from the lobby and then have separate exits from within a tunnel or ante-room model common to or replicated by each available zone therein. Alternatively they may be selected from a menu, either in the form of a pop-up menu, or from within the Home environment, such as by selecting from a set of signposts. In these latter cases the connecting tunnel or anteroom will appear to link only to the selected developer or publisher zone 1030. Alternatively or in addition, such zones may be selected via the map screen, resulting in the zone being loaded in to memory, and the avatar re-spawning within the selected zone.

Developer or publisher zones 1030 provide additional virtual environments, which may reflect the look and feel of the developer or publisher's products, brands and marks.

The developer or publisher zones 1030 are supplementary software modules to the Home environment and typically comprise additional 3D models and textures to provide the structure and appearance of the zone.

In addition, the software operable to implement the Home environment supports the integration of third party software via an application program interface (API). Therefore, developers can integrate their own functional content within the Home environment of their own zone. This may take the form of any or all of:
i. Downloading/streaming of specific content, such as game trailers or celebrity endorsements;
ii. Changes in avatar appearance, behaviour and/or communication options within the zone;
iii. The provision of one or more games, such as basketball 1032 or a golf range 1034, optionally branded or graphically reminiscent of the developer's or publisher's games;
iv. One or more interactive scenes or vignettes representative of the developer's or publisher's games, enabling the player to experience an aspect of the game, hone a specific skill of the game, or familiarize themselves with the controls of a game;
v. An arena, ring, dojo, court or similar area 1036 in which remotely played games may be represented live by avatars 1038, for spectators to watch.

Thus, for example, a developer's zone resembles a concourse in the developer's signature colours and featuring their logos, onto which open gaming areas, such as soccer nets, or a skeet range for shooting. In addition, a booth (not shown) manned by game-specific characters allows the user's avatar to enter and either temporarily change into the lead character of the game, or zoom into a first person perspective, and enter a further room resembling a scene from the featured game. Here the user interacts with other characters from the game, and plays out a key scene. Returning to the concourse, adverts for the game and other content are displayed on the walls. At the end of the zone, the concourse opens up into an arena where a 5-a-side football match is being played, where the positions of the players and the ball correspond to a game currently being played by a popular group, such as a high-ranking game clan, in another country.

In embodiments of the present invention, developer/publisher zones are available to download. Alternatively or in addition, to reduce bandwidth they may be supplied as demo content on magazine disks, or may be installed/upgraded from disk as part of the installation process for a purchased game of the developer or publisher. In the latter two examples, subsequent purchase or registration of the game may result in further zone content being unlocked or downloaded. In any event, further modifications, and timely advert and trailer media, may be downloaded as required.

A similar zone is the commercial zone 1040. Again, there may be a plurality of such commercial zones accessible in similar manner to the developer and publisher zones. Like developer/publisher zones 1030, commercial zones 1040 may comprise representative virtual assets of one or more commercial vendors in the form of 3D models, textures etc., enabling a rendering of their real-world shops, brands and identities, and these may be geographically and/or thematically grouped within zones.

Space within commercial zones may be rented as so-called ‘virtual real-estate’ by third parties. For example, a retailer may pay to have a rendering of their shop included within a commercial zone 1040 as part of a periodic update of the Home environment supplied via the Home environment server 2010, for example on a monthly or annual renewal basis. A retailer may additionally pay for the commerce facilities described above, either on a periodic basis or per item. In this way they can provide users of the Home environment with a commercial presence.

Again, the commercial zone comprises supplementary software that can integrate with the home environment via an API, to provide additional communication options (shop-specific names, goods, transaction options etc), and additional functionality, such as accessing an online database of goods and services for purchase, determining current prices, the availability of goods, and delivery options. Such functions may be accessed either via a menu (either as a pop-up or within the Home environment, for example on a wall) or via communication with automated avatars. Communication between avatars is described in more detail later.

It will be appreciated that developers and publishers can also provide stores within commercial zones, and in addition that connecting tunnels between developer/publisher and commercial zones may be provided. For example, a tunnel may link a developer zone to a store that sells the developer's games. Such a tunnel may be of a ‘many to one’ variety, such that exits from several zones emerge from the same tunnel in-store. In this case, if re-used, typically the tunnel would be arranged to return the user to the previous zone rather than one of the possible others.

In an embodiment of the present invention, the software implementing the Home environment has access to an online-content purchase system provided by the PS3 OS. Developers, publishers and store owners can use this system via an interface to specify the IP address and query text that facilitates their own on-line transaction. Alternatively, the user can allow their PS3 registration details and credit card details to be used directly, such that by selecting a suitably enabled object, game, advert, trailer or movie anywhere within the Home environment, they can select to purchase that item or service. In particular, the Home environment server 2010 can store and optionally validate the user's credit card and other details so that the details are ready to be used in a transaction without the user having to enter them. In this way the Home environment acts as an intermediary in the transaction. Alternatively such details can be stored at the PS3 and validated either by the PS3 or by the Home environment server.

Thus, referring now also to FIG. 7, in an embodiment of the present invention a method of sale comprises in a step s2102 a user selecting an item (goods or a service) within the Home environment. In step s2104, the PS3 10 transmits identification data corresponding with the object to the Home environment server 2010, which in step s2016 verifies the item's availability from a preferred provider (preferably within the country corresponding to the IP address of the user). If the item is unavailable then in step s2107 it informs the user by transmitting a message to the user's PS3 10. Alternatively, it first checks for availability from one or more secondary providers, and optionally confirms whether supply from one of these providers is acceptable to the user. In step s2108, the Home environment server retrieves from data storage the user's registered payment details and validates them. If there is no valid payment method available, then the Home environment may request that the user enters new details via a secure (i.e. encrypted) connection. Once a valid payment method is available, then in step s2110 the Home environment server requests from the appropriate third party payment provider a transfer of payment from the user's account. Finally, in s2112 the Home environment server places an order for the item with the preferred provider, giving the user's delivery address or IP address as applicable, and transferring appropriate payment to the preferred provider's account.

In this way, commerce is not limited specifically to shops. Similarly, it is not necessary for shops to provide their own commerce applications if the preferred provider for goods or services when displayed within a shop is set to be that shop's owner. Where the goods or service may be digitally provided, then optionally it is downloaded from the preferred provider directly or via a Home environment server 2010.

In addition to the above public zones, there are additional zones that are private to the individual user and may only be accessed by them or by invitation from them. These zones also have exits from the communal lobby area, but when entered by the avatar (or chosen via the map screen), load a respective version of the zone that is private to that user.

Referring to FIG. 8a, the first of these zones is an apartment zone 1050. In an embodiment of the present invention, this is a user-customisable zone in which such features 1052 as wallpaper, flooring, pictures, furniture, outside scenery and lighting may be selected and positioned. Some of the furniture is functional furniture 1054, linked to PS3 functionality. For example, a television may be placed in the apartment 1050 on which can be viewed one of several streamed video broadcasts, or media stored on the PS3 HDD 400 or optical disk 440. Similarly, a radio or hi-fi may be selected that contains pre-selected links to Internet radio streams. In addition, user artwork or photos may be imported into the room in the form of wall hangings and pictures.

Optionally, the user (represented in FIG. 8a by their avatar 1056) may purchase a larger apartment, and/or additional goods such as a larger TV, a pool table, or automated non-player avatars. Other possible items include a gym, swimming pool, or disco area. In these latter cases, additional control software or configuration libraries to provide additional character functionality will integrate with the home environment via the API in a similar fashion to that described for the commercial and developer/publisher zones 1030, 1040 described previously.

Such purchases may be made using credit card details registered with the Home environment server. In return for a payment, the server downloads an authorization key to unlock the relevant item for use within the user's apartment. Alternatively, the 3D model, textures and any software associated with an item may also be downloaded from the Home environment server or an authorised third-party server, optionally again associated with an authorization key. The key may, for example, require correspondence with a firmware digital serial number of the PS3 10, thereby preventing unauthorised distribution.

A user's apartment can only be accessed by others upon invitation from the respective user. This invitation can take the form of a standing invitation for particular friends from within a friends list, or in the form of a single-session pass conferred on another user, and only valid whilst that user remains in the current Home environment session. Such invitations may take the form of an association maintained by a Home environment server 2010, or a digital key supplied between PS3 devices on a peer-to-peer basis that enables confirmation of status as an invitee.

In an embodiment of the present invention invited users can only enter the apartment when the apartment's user is present within the apartment, and are automatically returned to the lobby if the apartment's user leaves. Whilst within the apartment, all communication between the parties present (both user and positional data) is purely peer-to-peer.

The apartment thus also provides a user with the opportunity to share home created content such as artwork, slideshows, audio or video with invited guests, and also to interact with friends without potential interference from other users within the public zones.

When invited guests enter a user's apartment, the configuration of the room and the furnishings within it are transmitted in a peer-to-peer fashion between the attendees using ID codes for each object and positional data. Where a room or item are not held in common between the user and a guest, the model, textures and any code required to implement it on the guest's PS3 may also be transmitted, together with a single-use key or similar constraint, such as use only whilst in the user's apartment and whilst the user and guest remain online in this session.

Referring to FIG. 8b, a further private space that may similarly be accessed only by invitation is the user's Trophy Room 1060. The Trophy Room 1060 provides a space within which trophies 1062 earned during game play may be displayed.

For example, a third-party game comprises seeking a magical crystal. If the player succeeds in finding the crystal, the third party game nominates this as a trophy for the Trophy Room 1060, and places a 3D model and texture representative of the crystal in a file area accessed by the Home environment software when loading the Trophy Room 1060. The software implementing the Home environment can then render the crystal as a trophy within the Trophy Room.

When parties are invited to view a user's trophy room, the models and textures required to temporarily view the trophies are sent from the user's PS3 to those of the other parties on a peer-to-peer basis. This may be done as a background activity following the initial invitation, in anticipation of entering the trophy room, or may occur when parties enter a connecting tunnel/anteroom or select the user's trophy room from the map screen. Optionally, where another party also has that trophy, they will not download the corresponding trophy from the user they are visiting. Therefore, in an embodiment of the present invention, each trophy comprises an identifying code.

Alternatively or in addition, a trophy room may be shared between members of a group or so-called ‘clan’, such that a trophy won by any member of the clan is transmitted to other members of the clan on a peer-to-peer basis. Therefore all members of the clan will see a common set of trophies.

Alternatively or in addition, a user can have a standing invitation to all members of the Home environment, allowing anyone to visit their trophy room. As with the commercial and developer/publisher zones, a plurality of rooms is therefore possible, for example a private, a group-based and a public trophy room. This may be managed either by selection from a pop-up menu or signposts within the Home environment as described previously, or by identifying a relevant user by walking up to their avatar, and then selecting to enter their (public) trophy room upon using the trophy room exit from the lobby.

Alternatively or in addition, a public trophy room may be provided. This room may display the trophies of the person in the current instance of the Home environment who has the most trophies or a best overall score according to a trophy value scoring scheme. Alternatively it may be an aggregate trophy room, showing the best, or a selection of, trophies from some or all of the users in that instance of the Home environment, together with the ID of the user. Thus, for example, a user could spot a trophy from a game they are having difficulty with, identify who in the Home environment won it, and then go and talk to them about how they won it. Alternatively, a public trophy room could contain the best trophies across a plurality of Home environments, identifying the best gamers within a geographical, age specific or game specific group, or even worldwide. Alternatively or in addition, a leader board of the best scoring garners can be provided and updated live.

It will be appreciated that potentially a large number of additional third party zones may become available, each comprising additional 3D models, textures and control software. As a result a significant amount of space on HDD 400 may become occupied by Home environment zones.

Consequently, in an embodiment of the present invention the number of third party zones currently associated with a user's Home environment can be limited. In a first instance, a maximum memory allocation can be used to prevent additional third party zones being added until an existing one is deleted. Alternatively or in addition, third party zones may be limited according to geographical relevance or user interests (declared on registration or subsequently via an interface with the Home environment server 2010), such that only third party zones relevant to the user by these criteria are downloaded. Under such a system, if a new third party zone becomes available, its relevance to the user is evaluated according to the above criteria, and if it is more relevant than at least one of those currently stored, it replaces the currently least relevant third party zone stored on the user's PS3.

Other criteria for relevance may include interests or installed zones of nominated friends, or the relevance of zones to games or other media that have been played on the user's PS3.

Further zones may be admitted according to whether the user explicitly installs them, either by download or by disk.

As noted above, within the Home environment users are represented by avatars. The software implementing the Home environment enables the customization of a user's avatar from a selection of pre-set options in a similar manner to the customization of the user's apartment. The user may select gender and skin tone, and customise the facial features and hair by combining available options for each. The user may also select from a wide range of clothing. To support this facility, a wide range of 3D models and textures for avatars are provided. In an embodiment of the present invention, user may import their own textures to display on their clothing. Typically, the parameters defining the appearance of each avatar only occupy around 40 bytes, enabling fast distribution via the Home environment server when joining a populated Home environment.

Each avatar in the Home environment can be identified by the user's ID or nickname, displayed in a bubble above the avatar. To limit the proliferation of bubbles, these fade into view when the avatar is close enough that the text it contains could easily be read, or alternatively when the avatar is close enough to interact with and/or is close to the centre of the user's viewpoint.

The avatar is controlled by the user in a conventional third-person gaming manner (e.g. using the game controller 751), allowing them to walk around the Home environment. Some avatar behaviour is contextual; thus for example the option to sit down will only be available when the avatar is close to a seat. Other avatar behaviour is available at all times, such as for example the expression of a selected emotion or gesture, or certain communication options. Avatar actions are determined by use of the game controller 751, either directly for actions such as movement, or by the selection of actions via a pop-up menu, summoned by pressing an appropriate key on the game controller 751.

Options available via such a menu include further modification of the avatar's appearance and clothing, and the selection of emotions, gestures and movements. For example, the user can select that their avatar smiles, waves and jumps up and down when the user sees someone they know in the Home environment.

Users can also communicate with each other via their avatars using text or speech.

To communicate by text, in an embodiment of the present invention, messages appear in pop-up bubbles above the relevant avatar, replacing their name bubble if necessary.

Referring now also to FIG. 9, to generate a message the user can activate a pop-up menu 1070 in which a range of preset messages is provided. These may be complete messages, or alternatively or in addition may take the form of nested menus, the navigation of which generates a message by concatenating selected options.

Alternatively or in addition, a virtual keyboard may be displayed, allowing free generation of text by navigation with the game controller 751. If a real keyboard 753 is connected via Bluetooth, then text may by typed into a bubble directly.

In an embodiment of the present invention, the lobby also provides a chat channel hosted by the Home environment server, enabling conventional chat facilities.

To communicate by speech, a user must have a microphone, such as a Bluetooth headset 757, available. Then in an embodiment of the present invention, either by selection of a speech option by pressing a button on the game controller 751, or by use of a voice activity detector within the software implementing the Home environment, the user can speak within the Home environment. When speaking, a speech icon may appear above the head of the avatar for example to alert other users to adjust volume settings if necessary.

The speech is sampled by the user's PS3, encoded using a Code Excited Linear Prediction (CELP) codec (or other known VoIP applicable codec), and transmitted in a peer-to-peer fashion to the eight nearest avatars (optionally provided they are within a preset area within the virtual environment surrounding the user's avatar). Where more than eight other avatars are within the preset area, one or more of the PS3s that received the speech may forward it to other PS3s having respective user avatars within the area that did not receive the speech, in an ad-hoc manner. To co-ordinate this function, in an embodiment of the present invention the PS3 will transmit a speech flag to all PS3s whose avatars are within the preset area, enabling them to place a speech icon above the relevant (speaking) avatars head (enabling their user to identify the speaker more easily) and also to notify the PS3s of a transmission. Each PS3 can determine from the relative positions of the avatars which ones will not receive the speech, and can elect to forward the speech to the PS3 of whichever avatar they are closest to within the virtual environment. Alternatively, the PS3s within the area can ping each other, and whichever PS3 has the lowest lag with a PS3 that has not received the speech can elect to forward it.

It will be appreciated that the limitation to eight is exemplary, and the actual number depends upon such factors as the speech compression ratio and the available bandwidth.

In an embodiment of the present invention, such speech can also be relayed to other networks, such as a mobile telephony network, upon specification of a mobile phone number. This may be achieved either by routing the speech via the Home environment server to a gateway server of the mobile network, or by Bluetooth transmission to the user's own mobile phone. In this latter case, the mobile phone may require middleware (e.g. a Java® applet) to interface with the PS3 and route the call.

Thus a user can contact a person on their phone from within the Home environment. In a similar manner, the user can also send a text message to a person on their mobile phone.

In a similar manner to speech, in an embodiment of the present invention users whose PS3s are equipped with a video camera such as the Sony® Eye Toy® video camera can use a video chat mode, for example via a pop-up screen; or via a TV or similar device within the Home environment, such as a Sony® Playstation Portable® (PSP) held by the avatar. In this case video codecs are used in addition to or instead of the audio codecs.

Optionally, the avatars of users with whom you have spoken recently can be highlighted, and those with whom you have spoken most may be highlighted more prominently, for example by an icon next to their name, or a level of glow around their avatar.

Referring back to FIG. 5, when a user selects to activate the Home environment on their PS3 10, the locally stored software generates the graphical representation of the Home environment, and connects to a Home environment server 2010 that assigns the user to one of a plurality of online Home environments 2021, 2022, 2023, 2024. Only four home environments are shown for clarity.

It will be understood that potentially many tens of thousands of users may be online at any one time. Consequently to prevent overcrowding, the Home environment server 2010 will support a large plurality of separate online Home environments. Likewise, there may be many separate Home environment servers, for example in different countries.

Once assigned to a Home environment, a PS3 initially uploads information regarding the appearance of the avatar, and then in an ongoing fashion provides the Home environment server with positional data for its own avatar, and receives from the Home environment server the positional data of the other avatars within that online Home environment. In practice this positional update is periodic (for example every 2 seconds) to limit bandwidth, so other PS3s must interpolate movement. Such interpolation of character movement is well-known in on-line games. In addition, each update can provide a series of positions, improving the replication of movement (with some lag), or improving the extrapolation of current movement.

In addition the IP addresses of the other PS3s 2031, 2032, 2033 within that Home environment 2024 is shared so that they can transmit other data such as speech in a peer-to-peer fashion between themselves, thereby reducing the required bandwidth of data handled by the Home environment server.

To prevent overcrowding within the Home environments, each will support a maximum of, for example, 64 users.

The selection of a Home environment to which a user will be connected can take account of a number of factors, either supplied by the PS3 and/or known to the Home environment server via a registration process. These include but are not limited to:
i. The geographical location of the PS3;
ii. The user's preferred language;
iii. The user's age;
iv. Whether any users within the current user's ‘friends list’ are in a particular Home environment already;
v. What game disk is currently within the user's PS3;
vi. What games have recently been played on the user's PS3.

Thus, for example, a Swiss teenager may be connected to a Home environment on a Swiss server, with a maximum user age of 16 and a predominant language of French. In another example, a user with a copy of ‘Revolution’ mounted in their PS3 may be connected to a Home environment where a predominant number of other users also currently have the same game mounted, thereby facilitating the organisation of multiplayer games. In this latter case, the PS3 10 detects the game loaded within the BD-ROM 430 and informs the Home environment server 2010. The server then chooses a Home environment accordingly.

In a further example, a user is connected to a Home environment in which three users identified on his friends list can be found. In this latter example, the friends list is a list of user names and optionally IP addresses that have been received from other users that the user given wishes to meet regularly. Where different groups of friends are located on different Home environment servers (e.g. where the current user is the only friend common to both sets) then the user may either be connected to the one with the most friends, or given the option to choose.

Conversely, a user may invite one or more friends to switch between Home environments and join them. In this case, the user can view their friends list via a pop-up to menu or from within the Home environment (for example via a screen on the wall or an information booth) and determine who is on-line. The user may then broadcast an invite to their friends, either using a peer-to-peer connection or, if the friend is within a Home environment or the IP address is unknown, via the Home environment server. The friend can then accept or decline the invitation to join.

To facilitate invitation, generally a Home environment server will assign less than the maximum supported number of users to a specific home environment, thereby allowing such additional user-initiated assignments to occur. This so-called ‘soft-limit’ may, for example, be 90% of capacity, and may be adaptive, for example changing in the early evening or at weekends where people are more likely to meet up with friends on-line.

Where several friends are within the same Home environment, in an embodiment of the present invention the map screen may also highlight those zones in which the friends can currently be found, either by displaying their name on the map or in association with the zone name on the side bar.

Referring now also to FIG. 10, in addition, preferences, settings, functions of the Home environment and optionally other functionality may be viewed, adjusted or accessed as appropriate by use of a virtual Sony® Playstation Portable® (PSP) entertainment device 1072 that can be summoned by use of the game controller 751 to pop-up on screen. The user can then access these options, settings and functionality via a PSP cross-media bar 1074 displayed on the virtual PSP. As noted above, the PSP could also be used as an interface for video chat.

When a user wishes to leave the Home environment, in embodiments of the present invention they may do so by selection of an appropriate key on the game controller 751, by selection of an exit option from a pop-up menu, by selection of an exit from within the map screen, by selection of an option via their virtual PSP or by walking through a master exit within the lobby zone.

Typically, exiting the Home environment will cause the PS3 10 to return to the PS3 cross media bar.

Finally, it will be appreciated that additional, separate environments based upon the Home environment software and separately accessible from the PS3 cross-media bar are envisaged. For example, a supermarket may provide a free disk upon which a Supermarket environment, supported in similar fashion by the Home environment servers, is provided. Upon selection, the user's avatar can browse displayed goods within a virtual rendition of the supermarket (either as 3D models or textures applied to shelves) and click on them to purchase as described above. In this way retailers can provide and update online shopping facilities for their own user base.

Referring now to FIG. 11, a further public zone (or part of an existing zone) is the dance zone 1080. Typically this resembles a disco or nightclub, having a central dance floor 1082 and optionally surrounded by seating areas and/or other sources of activity such as pool tables and the like (not shown). In addition, the dance zone provides music for dancing with and optionally disco lighting.

In such a zone, as described previously the positions and actions of other users' avatars are shared between the participating devices in the zone (typically via the Home environment server), and this will include information defining a type of dance style that other users have selected for their avatars (e.g. from a range of possible dance styles supported by the Home environment).

With this information the entertainment device can locally render each of the other user's avatars 1084, 1086, 1088, 1090 in their appropriate places, and locally animate them according to pre-set dance animations corresponding to the respective selected dance style.

In an embodiment of the present invention, the animations of each dance style share (i.e. are compatible with) a common tempo (as a non-limiting example, they may all take 1 second to complete their animation cycle, and/or within an animation cycle they may perform 4 actions at times determined by a common beat of known tempo).

As a result when the animation cycles of each avatar are initiated together, they appear to dance to the same beat or tempo irrespective of the individual dance style used.

It will be understood that different users will join the disco at different times. Whilst it is possible to stream music from a central server, thereby ensuring that all users hear the same current portion of the music, this can be expensive to the music provider and moreover the unpredictable effect of transmission delays to each user means that the music reproduced locally at each user's machine may not in any event be synchronised the animation of the avatars' dance actions without recourse to complex beat analysis, additional timing signals, or the like.

Consequently in an embodiment of the present invention music is played from a local data source (although that local data may first be downloaded from the Home environment server either initially or as a parallel background activity running ahead of reproduction). The local data source can be implemented as data storage on the HDD 400, a memory card connected to the card reader 450, a disk placed in the BD-ROM reader 430, a memory device connected to the USB port 710 or the like. In this case a transmitter of the Home environment server, acting as the administrator of various features of the environment, transmits an indicator of which music track is currently intended to be played on the dance floor, and the Cell Processor 100 along with the I/O Bridge 700 and the Ethernet port 720 and/or the WiFi receiver 730 collectively act as a receiver to receive such an indication.

In an embodiment of the present invention therefore each user hears the start of the current music begin when their avatar joins/approaches the disco or enters the zone (depending on designer preference).

However, the tempo (e.g. the beats-per-minute) of the music track is pre-arranged to be uniform substantially throughout the track and moreover to match the pre-set tempo of the dance animations of the avatars.

As a result each user of the dance floor will be hearing the same dance beat irrespective of where in their individual rendition of the music track they happen to be.

The effect of this for each user is that they appear to join at the start of a music track, and other users' avatars dance in time to it according to their own style; meanwhile each other user has the impression that their own avatar has been dancing to a different part of the music depending on when they joined the disco.

Precise synchronisation of the dance moves to the musical beat can be achieved because the animation cycle and music are locally controlled by the entertainment device, for example using the Home system clock. Because all the avatars of other users are also rendered locally, the animation cycles of each avatar can be properly synchronised with the local rendition of the music.

In an embodiment of the present invention, events within the Home environment can cause the music track to change. For example, the music may change from a salsa track to a rock track.

This introduces a potential problem, in that different users will be at different points in the rendition of the current music track, making a responsive, coordinated and musically harmonious change difficult.

In an embodiment of the present invention, in order to provide a responsive change in music when such events occur, whilst recognising that each user may be playing a different part of the current music track, the Cell Processor 100 of the entertainment device monitors the track for so-called changeover points or breakpoints. These may occur for example at every two or four bars of music, and may for example be represented by metadata associated with the music, or a timestamp, or by playback duration, or in the case where the music is generated (e.g. from a midi sequence) by indicators in such a sequence.

At the next changeover point to occur after a music changing event, as selected by the Cell Processor 100, the music track is replaced (under the control of the Cell Processor) with a segue track, which is substantially shorter than the main music track, or at least it is shorter than that portion of the main music track which remains unplayed at the time of the substitution. The segue track is preferably of substantially the same music or music style (for example a salsa music track will be replaced by a similar salsa segue track), but the segue track brings the music to an end within a predetermined and short period of time, such as for example over four bars.

In this way, one style of music or music track is brought to an end neatly and at roughly the same time for all users irrespective of where in the playback of the original track each user actually was.

In an embodiment of the present invention, the new music track begins immediately after the segue track.

Alternatively or in addition, in an embodiment of the present invention this process is used in the case where the new music track is of the same style (or is the same track) as the old music track, thereby synchronising the current population of the dance floor to the current track in an unobtrusive manner. The new music track may of course not start at the very beginning but may start mid-way through (for example at a changeover point in the music track, so that the beat and tempo are maintained). In this case a segue track is selected that provides typically four bars of appropriate music, rather than a segue track that brings the music to an end.

Thus, by way of an example scenario, an instrumental rock music track is currently playing that is 04:00 minutes long. Amongst the users are those listening to the track at respective track times 00:30, 01:15 and 01:40. A transmitter of the Home environment server issues a synchronisation event signal to the connected entertainment devices, and at their next respective changeover point in the music after receipt of that signal, each entertainment device switches to the (or a respective) segue track, and then afterwards back to the rock music track starting at a predetermined changeover point occurring at track time 01:00. All the users will then be synchronised to within one changeover point period, and hence typically to within two or four bars of music, without any intrusive break in musical reproduction, beat, or tempo.

It will also be appreciated that if desired then for example a rock music track can be constructed from a sequence of rock music segue tracks, in order to provide maximum flexibility in synchronising and resynchronising the dance floor population. Such sequences can be predetermined, random, or responsive to events in the Home environment, or a mix of any or all of these. Such an approach can also provide relatively long periods of ambient music for comparatively little music data memory storage.

In an embodiment of the present invention, and particularly where the old music track is brought to an end, the new music track can be triggered centrally so that (within a tolerance due to transmission lag for the trigger) users currently on the dance floor become more closely synchronised in their musical playback, thereby improving the scope to comment on the music, for example, or initiate a gestural flourish at a dramatic moment in the music that will be appreciated by others. Such triggering may be by a commencement signal from the Home environment.

In another embodiment, the new music track is cross-faded with the segue track.

In another embodiment, more music is not played straight away—for example, the music may have been ended in order to make an announcement or make way for some other activity.

The Home environment's synchronisation event signal may take the form of a single specific event signal or may be an instance of a more generalised music event signal format wherein the signal comprises an indication of a selected segue music track and a selected next music track, optionally with the intended start time or breakpoint. Thus a synchronisation event signal is a music event signal defining the particular case where the segue track is a continuation of the music and the next music track is the same as the previous music track. By contrast a changeover event signal is a music event signal defining a case where the indicated segue track brings the current music to a close, and the indicated next music track is different to the previous music track.

In an embodiment of the present invention, an event that determines the choice of music style is a poll of avatar dance styles on the dance floor, carried out by a receiver or the Home environment server receiving from respective PS3s dance style information for their corresponding avatars. Thus for example if the majority of avatars were previously dancing in a rock style, but are now dancing in a salsa style, then this is evaluated to be the dominant style and the Home environment server may issue an indication (a music event synchronisation signal) that the music may or should switch at (or after a segue track following) the next changeover point, from rock to salsa.

Hysteresis may be applied to the changeover process, so that one individual cannot repeatedly flip the whole disco between musical styles. For example the musical style may be maintained for a minimum of 1 minute after a change. Optionally such hysteresis may only be applied where there is less than a threshold difference between the number of users adopting a first dance style and a second dance style, as this is when abuse of the changeover process is most feasible by one or two individuals.

The Home environment server may change musical styles in response to a minimum threshold of avatars all dancing the same style (for example as a new instance of a dance zone becomes populated) and/or based upon the proportion of avatars adopting a dance style. This in turn may require more than 50% or simply be the most popular, again optionally subject to a minimum proportion threshold such as 25%. Such values are for example only, and in practice are at the zone designer's discretion.

Such a poll may be conducted in the period between changeover points in the music, or immediately preceding such points, or according to some other schedule, typically by the Home environment server. The Home environment server routes information such as current dance styles between connected entertainment devices during normal operation, and so can monitor the distribution of dance styles within the virtual environment without further specific communications.

It will be appreciated that in principle the above polling may be done by each respective entertainment device, as it receives sufficient information to determine the current dominant dance style and hence the appropriate musical style. However to ensure the same music subsequent selection, either the music must be selected according to a fixed scheme (which is relatively inflexible to the introduction of new music and may become repetitive for users), or the entertainment devices must request a music track (or contention between proposed music tracks) from the Home environment server in any case.

Alternatively or in addition, dancers and optionally other users of the zone may explicitly vote for the next music track, for example via a pop-up menu or an in-game interface such as an interactive screen in the virtual environment. The music may change at a scheduled point or in the event that a threshold number of votes is reached for a particular music style or track.

Finally, where no other event occurs to change musical style, in an embodiment of the present invention the Home environment server will change the musical style after a period of time; for example, after three repetitions of a track (or style), or after five minutes.

In an embodiment of the present invention, the dance floor itself is reactive to the avatars on it. One or more of the available dance styles (and potentially all of them) cause a corresponding light show 1084a to occur on the dance floor around the dancing avatar. This light show may comprise colours and patterns of lights within the dance floor surface that are specific to a particular dance style. Where light shows associated with different avatars overlap, they may result in new colour combinations or patterns. Where avatars are dancing the same type of dance within a predetermined threshold distance of each other, in an embodiment of the present invention the light show expands to encompass both avatars 1086a, 1088a, and optionally introduces new colours and/or light patterns.

In an embodiment of the present invention, once a threshold number of avatars are all dancing with the same style, a special event is triggered, such as a release of balloons for a predetermined period of time, a special ‘celebration’ dance move, and/or the whole dance floor lighting up with the light show associated with that dance style. In addition at this point new dance animations may be used that are particularly effective for large groups, such as for example line dancing moves that users can exploit by arranging their avatars appropriately on the dance floor.

Where more than one dance style exceeds the threshold, the most popular one is used or, alternatively, the dance floor is split to form several light shows, optionally with each encompassing the largest number of their corresponding dancers.

In addition to polling user animations to determine a preferred musical style, the dance zone can poll other user gestures, such as positive or negative gestures (e.g. thumbs up or thumbs down) received by the Home environment server from the respective PS3s, to generate a voting system that integrates naturally with the dance moves. In this way users can hold impromptu talent shows, for example using voice chat to perform Karaoke and receive votes from others on the dance floor.

In an embodiment polling for such votes is limited to those receiving audio based on the standard method of audio communication between users described previously herein (for example between the eight closest avatars). Alternatively the dance zone may be specifically provided with a stage area or podium 1092, and if a user places their avatar within a trigger region 1094 of that stage area or podium they can broadcast audio to all users of the zone, or dance floor (again typically via the Home environment server), and in this case all such users can vote by use of gestures.

Votes can be aggregated over the course of a performance or alternatively over a specified time period.

Performers who get a good approval rating may get a special lightshow around their avatar and/or some other visual indication of approval or reward. Conversely performers who get a poor rating may lose their lightshow and/or get some other visual indication of disapproval.

It will be appreciated that the above techniques advantageously provide a means of substantially synchronising musical events on a dance floor populated by a plurality of remotely connected users, without the need for centrally broadcasting (or ‘webcasting’) the music itself. Moreover the above technique enables quick musical reactivity to events in the Home environment (such as a change in majority dance style) for all remotely connected participants, irrespective of where in the respective playback of the music each participant's entertainment device is.

The effect is to provide coordinated, responsive music in an on-line environment without centrally broadcasting that music.

A further subsequent advantage is that by locally reproducing the music on each entertainment device connected to the Home environment, the dance animations of all dancing avatars can be synchronised with the locally produced music without the need to account for network lag.

To yet further improve this effect, the animations and music are arranged to be compatible in each combination, so that any dances styles—and multiple dance styles across the on-line population—can be harmoniously displayed with any selected music track.

Referring now to FIG. 12, a method of administering a virtual dance floor for an entertainment device, where the virtual dance floor is part of an online virtual environment that is operable to host a plurality of users each connecting to the online virtual environment using a respective entertainment device, and where each user is represented in the virtual environment by an avatar, comprises for each respective entertainment device:

in a first step s110, receiving from an administrator of the online virtual environment an indicator of the music currently being played on the virtual dance floor;

in a second step s120, initiating playback of the music from a locally stored copy in response to a placement of the avatar of the respective user within the online virtual environment;

in a third step s130, detecting breakpoints in the currently played music;

in a fourth step s140, receiving from the administrator of the online virtual environment a music event signal;

in a fifth step s150, in response to receiving the music event signal selecting the next detected breakpoint in the currently played music; and

in a sixth step s160, substituting the currently played music at the selected breakpoint with a piece of music of a predetermined length that is substantially shorter than the currently played music it replaces.

It will be apparent to a person skilled in the art that variations in the above method corresponding to operation of the various embodiments of the apparatus as described and claimed herein are considered within the scope of the present invention, including but not limited to:
the step of substitution comprising one selected from the list consisting of:
   playing different music upon completion of the shorter piece of music;
   playing a music track upon receipt of a commencement signal from the administrator of the online virtual environment after completion of the segue track
   playing the music previously replaced by the shorter piece of music upon completion of the shorter piece of music, beginning playback from a predetermined breakpoint other than the start of the music; and
   not playing music upon completion of the shorter piece of music;
   incorporating lighting effects in the dance floor of the virtual environment corresponding to a respective dance style, the lighting effects being positioned in accordance with one or more selected from the list consisting of:
   the location of an avatar dancing with the respective dance style;
   the combined locations of two or more avatars dancing with the respective dance style and located within a threshold distance of each other; and
   substantially over the whole dance floor if a threshold number or proportion of avatars dance with the respective dance style;
   receiving dance style information for one or more avatars corresponding to users of the one or more remote entertainment devices, initiating dance animations for one or more avatars corresponding to respective received dance style information, initiating a dance animation for the user's avatar responsive to a dance style selection made by the user, and arranging each dance animation and each selected music track to all share the same tempo, so that each dancing avatar can appear to dance in time to the beat irrespective of the selected music track or dance style;

Referring now to FIG. 13, a method of administering a virtual dance floor for a server, where the virtual dance floor is part of an online virtual environment that is operable to host a plurality of users each connecting to the online virtual environment using a respective entertainment device, and where each user is represented in the virtual environment by an avatar, comprises:

in a first step s210, receiving from respective remote entertainment devices dance style information for their corresponding avatars;

in a second step s220, evaluating the number of avatars dancing each of a number of available dance styles;

in a third step s230, selecting a dominant dance style based upon the evaluation;

in a fourth step s240, detecting whether the dominant dance style changes between successive evaluations;

in a fifth step s250, selecting music responsive to the dominant dance style; and

in a sixth step s260, transmitting a music event signal to the remote entertainment devices to substitute the music currently played by each of the remote entertainment devices with a piece of music of a predetermined length that is substantially shorter than the music that it replaces, and then to subsequently play a piece of music responsive to the dominant dance style.

It will be apparent to a person skilled in the art that variations in the above method corresponding to operation of the various embodiments of the apparatus as described and claimed herein are considered within the scope of the present invention, including but not limited to:
receiving from respective remote entertainment devices avatar gesture information for their corresponding avatars, counting the number of avatars adopting each of a number of available positive or negative gestures, evaluating a positive or negative vote based upon the count, and modifying a property of the virtual environment in response to the outcome of the vote;
   in which the modified property of the virtual environment is associated with an avatar corresponding to a user who was performing using a voice transmission facility;
transmitting music event signals that may variously
   segue into an ending of a piece of music;
   coordinate the segue of one musical style into another; and
   coordinate the segue from disparate parts of the same music track on respective remote entertainment devices to substantially a same part of the same music track on each respective remote entertainment device.

Finally, it will be appreciated that the methods disclosed herein may be carried out on conventional hardware suitably adapted as applicable by software instruction or by the inclusion or substitution of dedicated hardware.

Thus the required adaptation to existing parts of a conventional equivalent device may be implemented in the form of a computer program product or similar object of manufacture comprising processor implementable instructions stored on a data carrier such as a floppy disk, optical disk, hard disk, PROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable circuit suitable to use in adapting the conventional equivalent device.

1. An entertainment device comprising:
a display generator arranged to generate for display a representation of an on-line virtual environment, and to generate for display within the representation of the on-line virtual environment an avatar controlled by a user of the entertainment device and one or more avatars corresponding to users of one or more remote entertainment devices, the avatars being animated in response to a replayed music track;
a receiver operable to receive from an administrator of the online virtual environment an indicator of a music track currently selected for use in the virtual environment, and operable to receive from the administrator a music event signal;
music data storage operable to store a local copy of one or more music tracks; and
a processor operable to initiate playback of the selected music track from a locally stored copy in response to an initial placement of the user's avatar within the online virtual environment, and operable to detect breakpoints in the currently played music track;
in which:
the processor is operable to select the next breakpoint in the currently played music track following reception of a music event signal, and to substitute the currently played music track at the selected breakpoint with a shorter piece of music of a predetermined length that is shorter than that portion of the currently played music track that it replaces which remains unplayed at the time of the substitution.

2. An entertainment device according to claim 1, in which, following substitution of a music track with a shorter piece of music, the processor is operable to do one selected from the list consisting of:
i. play a different music track upon completion of the shorter piece of music;
ii. play the music track previously replaced by the shorter piece of music upon completion of the shorter piece of music, beginning playback from a predetermined breakpoint other than the start of the music track;
iii. play a music track upon receipt of a commencement signal from the administrator of the online virtual environment after completion of the shorter piece of music; and
iv. not play a music track upon completion of the shorter piece of music.

3. An entertainment device according to claim 1, in which the virtual environment comprises a virtual dance floor.

4. An entertainment device according to claim 3, in which:
the receiver is operable to receive, from the administrator and/or the one or more remote entertainment devices, dance style information for one or more avatars corresponding to users of the one or more remote entertainment devices;
the processor is operable to initiate dance animations for one or more avatars corresponding to respective received dance style information, and to initiate a dance animation for the user's avatar responsive to a dance style selection made by the user;
and wherein each dance animation and each selected music track are arranged to all share the same tempo, so that each dancing avatar can appear to dance in time to the beat irrespective of the selected music track or dance style.

5. An entertainment device according to claim 3, in which:
the processor and display generator are operable to incorporate lighting effects in the virtual dance floor of the virtual environment corresponding to a respective dance style, the lighting effects being positioned in accordance with one or more selected from the list consisting of:
i. the location of an avatar dancing with the respective dance style;
ii. the combined locations of two or more avatars dancing with the respective dance style and located within a threshold distance of each other; and
iii. substantially over the whole dance floor if a threshold number or proportion of avatars dance with the respective dance style.

6. An entertainment device according to claim 1, in which the processor is operable to select, as a shorter piece of music to be substituted for a currently played track, a shorter piece of music of the same musical style as that of the currently played track.

7. A server arranged to administer a virtual environment, to which a plurality of remote entertainment devices may connect, wherein each remote entertainment device is represented within the virtual environment by an avatar, the server comprising:
a transmitter operable:
(a) to transmit to each remote entertainment device an indicator of a music track currently selected for replay in the virtual environment; and
(b) to transmit a music event signal to instruct the remote entertainment devices to substitute music currently played by each of the remote entertainment devices with a shorter piece of music of a predetermined length that is shorter than that portion of the music track that it replaces which remains unplayed at the time of the substitution.

8. A server according to claim 7, in which the virtual environment comprises a dance floor.

9. A server according to claim 7, comprising:
a receiver operable to receive from respective remote entertainment devices dance style information for their corresponding avatars; and
a processor operable to evaluate the number of avatars dancing each of a number of available dance styles, operable to select a dominant dance style based upon the evaluation, and operable to select a next music track responsive to the dominant dance style;
and wherein
the processor is arranged to detect whether the dominant dance style changes between successive evaluations, and if so to cause the transmitter to transmit a music event signal that indicates a change of music style.

10. A server according to claim 9, in which the server is arranged to retain the current music selection for a predetermined minimum period irrespective of the current dominant dance style.

11. A server according to claim 7, comprising:
a receiver operable to receive from respective remote entertainment devices avatar gesture information for their corresponding avatars; and
a processor operable to count the number of avatars adopting each of a number of available positive or negative gestures, operable to evaluate a positive or negative vote based upon the count, and operable to modify a property of the virtual environment in response to the outcome of the vote.

12. A server according to claim 11, in which the on-line environment facilitates voice communication between users, and the modified property of the virtual environment is associated with the avatar corresponding to a user who was performing using the voice transmission facility.

13. A method of administering an online virtual environment for an entertainment device, wherein the virtual environment is operable to host a plurality of users each connecting to the online virtual environment using a respective entertainment device, and where each user is represented in the virtual environment by an avatar, and for each respective entertainment device the method comprises the steps of:
receiving from an administrator of the online virtual environment an indicator of the music currently being played;
initiating playback of the music from a locally stored copy in response to an initial placement of the avatar of the respective user within the online virtual environment;
detecting breakpoints in the currently played music;
receiving from the administrator of the online virtual environment a music event signal;
and in response to receiving the music event signal,
selecting the next detected breakpoint in the currently played music,
and substituting the currently played music at the selected breakpoint with a shorter piece of music of a predetermined length that is shorter than that portion of the currently played music that it replaces which remains unplayed at the time of the substitution.

14. A method according to claim 13, in which the step of substitution comprises one selected from the list consisting of:
i. playing different music upon completion of the shorter piece of music;
ii. playing the music previously replaced by the shorter piece of music upon completion of the shorter piece of music, beginning playback from a predetermined breakpoint other than the start of the music;
iii. play a music track upon receipt of a commencement signal from the administrator of the online virtual environment after completion of the shorter piece of music; and
iv. not playing music upon completion of the shorter piece of music.

15. A method according to claim 13, in which the virtual environment comprises a virtual dance floor.

16. A method according to claim 15, comprising the step of:
incorporating lighting effects in the virtual dance floor of the virtual environment corresponding to a respective dance style, the lighting effects being positioned in accordance with one or more selected from the list consisting of:
i. the location of an avatar dancing with the respective dance style;
ii. the combined locations of two or more avatars dancing with the respective dance style and located within a threshold distance of each other; and
iii. substantially over the whole dance floor if a threshold number or proportion of avatars dance with the respective dance style.

17. A method of administering an online virtual environment for a server, wherein the online virtual environment is operable to host a plurality of users each connecting to the online virtual environment using a respective entertainment device, and where each user is represented in the virtual environment by an avatar, the method comprising the steps of:
receiving from respective remote entertainment devices dance style information for their corresponding avatars;
evaluating the number of avatars dancing each of a number of available dance styles;
selecting a dominant dance style based upon the evaluation;
detecting whether the dominant dance style changes between successive evaluations;
selecting music responsive to the dominant dance style; and
transmitting a music event signal to the remote entertainment devices to substitute the music currently played by each of the remote entertainment devices with a shorter piece of music of a predetermined length that is shorter than that portion of the music that it replaces which remains unplayed at the time of substitution, and then to subsequently play a piece of music responsive to the dominant dance style.

18. A method according to claim 17, comprising the steps of:
receiving from respective remote entertainment devices avatar gesture information for their corresponding avatars;
counting the number of avatars adopting each of a number of available positive or negative gestures;
evaluating a positive or negative vote based upon the count; and
modifying a property of the virtual environment in response to the outcome of the vote.

19. A tangible, non-transitory computer program product on which computer readable instructions of a computer program are stored, the instructions, when executed by a processor, cause the processor to perform a method of administering an online virtual environment for an entertainment device according to claim 13.

20. A tangible, non-transitory computer program product on which computer readable instructions of a computer program are stored, the instructions, when executed by a processor, cause the processor to perform a method of administering an online virtual environment for a server according to claim 17.
